(19) United States
(12) Patent Application Publication
(10) Pub. No.: US 2016/0281673 A1
(43) Pub. Date: Sep. 29, 2016

(54) IGNITION SYSTEM AND METHOD FOR OPERATING AN IGNITION SYSTEM

(71) Applicant: ROBERT BOSCH GMBH, Stuttgart (DE)

(72) Inventors: Tim Skowronek, Missen-Wilhams (DE); Thomas Pawlak, Immenstadt (DE); Wolfgang Sinz, Hergatz (DE)

(21) Appl. No.: 15/036,040

(22) PCT Filed: Oct. 16, 2014
(86) PCT No.: PCT/EP2014/072216

§ 371 Date: May 11, 2016

(30) Foreign Application Priority Data
Nov. 14, 2013 (DE) 10 2013 223 195.4
Aug. 13, 2014 (DE) 10 2014 216 040.5

(51) Int. Cl. F02P 5/15; F02P 9/00

(52) U.S. Cl. CPC F02P 5/1502; F02P 9/002

(57) ABSTRACT

A method is described for operating an ignition system for an internal combustion engine, including a primary voltage generator and a boost converter for maintaining a spark generated with the aid of the primary voltage generator. An ascertainment of a modified energy requirement for an ignition spark to be maintained with the aid of the boost converter is followed by a modification of a switch-on time of the boost converter relative to a switch-off time of the primary voltage generator.

### FIELD

The present invention relates to a method for operating an ignition system for an internal combustion engine, including a first voltage generator (also “primary voltage generator”) and a boost converter. The present invention relates, in particular, to an avoidance of an undesirable spark breakaway during operation.

### BACKGROUND INFORMATION

Ignition systems are used in order to ignite an ignitable mixture in a combustion chamber of a spark ignited internal combustion engine. For this purpose, an ignition spark gap is acted on with electrical energy or a voltage, in response to which the forming ignition spark ignites the combustible mixture in the combustion chamber. The main requirements of modern ignition systems are an indirect result of required emissions and fuel reductions. Requirements of ignition systems are derived from corresponding engine-related approaches, such as supercharging and lean burn operation and shift operation (spray-guided direct injection) in combination with increased exhaust gas recirculation rates (EGR). The representation of increased ignition voltage requirements and energy requirements in conjunction with increased temperature requirements is necessary. In conventional inductive ignition systems, the entire energy required for ignition must be temporarily stored in the ignition coil. The stringent requirements with respect to ignition spark energy result in a large ignition coil design. This conflicts with the requirements for smaller installation spaces of modern engine concepts (“downsizing”). In an earlier application by the applicant, two main functions of the ignition system were assumed by different assembly units. A high voltage generator generates the high voltage necessary for the high voltage spark-over at the spark plug. A bypass, for example, in the form of a boost converter, provides energy for maintaining the ignition spark for continued mixture ignition. In this way, high spark energies may be provided at an optimized spark current profile despite a reduced ignition system design.

High spark currents are more robust in the combustion chamber as opposed to turbulent current, but they are known to result in stronger erosion of the spark plug electrodes. In contrast, small spark currents may result in a spark breakaway in the case of turbulent current in the combustion chamber, in the event the ignition spark energy or the spark current falls below a defined limit. The prior known systems do not satisfactorily exhaust the potential for spark stabilization in ignition systems.

### SUMMARY

In accordance with an example embodiment of the present invention, spark energy is provided according to demand so that the spark current may be set to a desired value. In this way a compromise may be achieved in a suitable manner between electrode erosion and the tendency toward spark breakaway. The example method according to the present invention for operating an ignition system is particularly suited for a gasoline-operated internal combustion engine, in which particular advantages in spray-guided direct injections and turbo-charged high load EGR are achieved. The ignition system, with which the method according to the present invention is carried out, includes a primary voltage generator and a boost converter, the boost converter being configured to maintain a spark generated with the aid of the primary voltage generator. Via the boost converter, it is possible to bring vehicle electrical system energy to a suitable voltage level and to guide it to the spark gap. The example method according to the present invention is distinguished by ascertaining a modified energy requirement for an ignition spark to be maintained with the aid of the boost converter. In other words, the energy requirement for the ignition spark may vary as a function of an instantaneous operating state and such a variation may be ascertained according to the present invention. In response thereto, the switch-on time of the boost converter, i.e., the point in time at which the boost converter is switched on, is modified in order to dose the ignition spark energy, or ignition spark current and ignition spark voltage according to need. In this way, the spark plug wear is reduced through the avoidance of high spark currents. A particularly severe electrode wear occurs in commercially available spark plugs, for example, at spark currents greater than 100 mA. On the other hand, a spark breakaway resulting from the increase in the power output of the boost converter is avoided by advancing the switch-on time of the boost converter and shifting the transient effect of the boost converter in the direction of “advance,” in particular, before the ignition time, when a lower spark current threshold value is undercut. Since the voltage generated by a boost converter, once switched on, increases over multiple operating cycles, the boost converter may therefore provide higher electrical energy upon ignition of the mixture. The reduction of heat loss in the boost converter by selecting its switch-on time according to need is also an advantage of the present invention. The load of the electrical components (for example, of a high voltage capacitor for intermediate storage of electrical energy) is reduced. The electrical components may therefore be selected more cost effectively when designing the ignition system according to the present invention. In the electrical (control) circuitry as well, less heat loss is generated when the working mode of the boost converter is adjusted to a modified energy requirement. On the whole, the present invention allows for a lower energy consumption and the reliable ignition of the mixture during demanding combustion processes of the ignition system from the vehicle electrical system (for example, of a motor vehicle or a passenger vehicle), as a result of which cable cross sections may be smaller dimensioned and consumption advantages may be achieved. Moreover, lower currents within the ignition system mean a reduction of electromagnetic emissions. In other words, the electromagnetic compatibility (EMC) is improved.

The ascertainment of the modified energy requirement preferably includes a measurement of an ignition spark current or an ignition spark voltage. This may take place using a shunt, for example, via which a current through the ignition spark gap of the ignition system is ascertained. The voltage may be ascertained, for example, with the aid of an electrical circuit, an analog circuit or a microcontroller, or by an ASIC within the ignition system. This requires fewer or no additional hardware outlays for implementing the method according to the present invention.

The ascertainment of the modified energy requirement also preferably includes a comparison of a measured electrical parameter of an ignition spark, or of a signal received by an electronic control unit, with an assigned reference. The reference may, for example, be retrieved from a memory medium.

This reference characterizes threshold values, for example, during the exceeding of which the ignition spark energy should be lowered to avoid erosion and during the undercutting of which the ignition spark energy should be increased to avoid an undesired spark breakaway. For example, threshold values in the form of ignition spark currents and/or ignition spark voltages may be saved as electrical parameters and compared with ascertained parameters. An engine control unit or an ignition control unit may be used as the electronic control unit, the evaluation electronics of which ascertains and provides signals for controlling the operation of the internal combustion engine. The comparison of measured values or control signals with individual threshold values represents a simple mathematical operation which, in terms of circuitry, is implementable in a cost-effective and space-saving manner.

The example method further preferably includes the step of classifying the electrical parameter by assigning a measuring value for the electrical parameter to a predefined parameter interval, for example, within a memory medium of the ignition system. Moreover, the switch-on time may be predefined by the control unit by taking into account the requirements of the combustion process. For example, engine operating states may be ascertained and taken into account. One example for one such state is an exhaust gas recirculation in partial load operation, which results in a relatively homogenous mixture state within the combustion chamber. In such a state, the boost converter is not required to be before the switch-off time of the primary voltage generator (ignition time). An overlap between the operation of the boost converter and the switch-off time (ignition timing) of the primary voltage generator) is advisable at an operating point with exhaust gas recirculation in high-load operation. In turn, an overlap between the operation of the boost converter and the switch-off time (ignition timing) of the primary voltage generator is not required in an operating state in which the catalytic converter is to be heated. In a shift operation, in turn, a non-homogenous mixture composition is present within the combustion chamber, in which an overlap between the operation of the boost converter and the switch-off time of the primary voltage generator is advantageous. The ignition system in this case may be configured to assign suitable switch-on times for the boost converter to respective parameter classes. The switch-on times may, for example, be assigned to the respective parameter class within a memory medium of the ignition system, and applied in response to a classification when determining the switch-on time of the boost converter. This operation is also a low-cost and, in terms of circuitry, simple and rapidly achievable option for implementing the present invention.

The parameter is further preferably ascertained within an FPGA and/or an ASIC of the ignition system. The aforementioned electronic components are situated, for example, within the ignition system, in particular, in the area of each spark plug for controlling the ignition process, the control of the ignition process being able to take place by way of contact with the spark plug. Thus, an implementation of the present invention is possible in this way without further hardware outlays.

The switch-on time is further preferably modified in response to a reduced energy requirement of the ignition system for a successful ignition. If the switch-on time of the boost converter is delayed as compared to the point in time of a switch-off of the primary voltage generator (so that it coincides, for example, with a point in time of a switch-off of the primary voltage generator), the current output and/or the voltage output and/or the power output of the boost converter is reduced at the switch-off time of the primary voltage generator, which results in a reduction of the corresponding electrical variable at the spark gap. In the reversed case, an advanced switching on of the boost converter in response to an increased energy requirement relative to the point in time of a switch-off of the primary voltage generator results in an increase in the current output and/or the voltage output and or the power output of the boost converter. In this way, a spark erosion as well as a breakaway of the ignition spark may be effectively avoided or reduced.

It may be very advantageous if the switch-on time is modified as a function of the operating state and/or as a function of the ascertained energy requirement. According to one exemplary embodiment, the switch-on time in a first ignition process is predefined as a function of the operating state, and for the following ignition processes determined as a function of the ascertained energy requirement. In this way, spark energy is provided according to demand.

It may also be advantageous if the ascertainment of the modified energy requirement in a first step includes the ascertainment of an electrical parameter and/or a change of this parameter and/or a change speed of this parameter, whereby the electrical parameter may be, in particular, a current of the ignition spark and/or a voltage characterizing a voltage of the ignition spark. In a second step, it is checked whether an exceedance condition and/or undercut condition is met, by ascertaining whether a comparison variable exceeds a predetermined upper threshold value and/or undercuts a predetermined lower threshold value. The comparison value is, for example, the ascertained parameter or the change of this ascertained parameter or the change speed of this ascertained parameter. The switch-on time is modified by shifting the switch-on time to a later point in time relative to the switch-off time of the primary voltage generator if the exceedance condition is met, or by shifting the switch-on time to an earlier point in time relative to the switch-off time of the primary voltage generator when the undercut condition is met. In this way, the spark current is adjusted to a value so that neither a spark breakaway is imminent, nor a strong erosion of the spark plug electrode occurs.

The ignition system designed for an internal combustion engine, with the aid of which the example method according to the present invention is carried out, includes a boost converter for maintaining a spark generated with the aid of a primary voltage generator. The ignition system is characterized by an element for ascertaining a modified energy requirement for an ignition spark to be maintained with the aid of the boost converter. In other words, the element is able to ascertain an operating state change of the ignition system or the internal combustion engine, in response to which the spark plug is to be supplied with a modified electrical energy or a modified electrical output in order to avoid both a spark breakaway and excessive wear of the ignition system. In addition, the manipulated variable may be predefined via the control unit as a function of the combustion process. The ignition system according to the present invention also includes an element for modifying a switch-on time of the boost converter in response to an ascertained energy requirement change. This element is configured in accordance with the modified energy requirement to adjust the switch-on time of the boost converter, for example, relative to the crank angle of the internal combustion engine of a speed-dependent variable or relative to the switch-off time of the primary voltage generator in order to feed a modified output to the spark gap. The features, feature combinations and the resulting advantages correspond essentially to those explained in conjunction with the first named inventive aspect, so that in order to avoid repetitions, reference is made to the above explanations.

For example, the ignition system includes a shunt, with the aid of which it is configured to carry out an ignition spark current measurement, in order to ascertain a modified energy requirement. Alternatively, an inference may be made via a voltage measurement about the level of the spark current. A defined output is delivered by the operation of the boost converter. Thus, current and voltage have a fixed relationship to one another. The voltage measurement via the shunt may take place, for example, via an FPGA and/or an ASIC of the ignition system. In addition, an ignition spark voltage ascertained without the use of a shunt may also be used by the aforementioned integrated circuitry for ascertaining a changed energy requirement of the ignition spark gap. In this case, the electrical parameter to be ascertained also includes currents, voltages and/or outputs. Since present ignition systems sometimes include an ASIC at each combustion chamber or at each spark plug, the ignition system may be implemented with minimal hardware outlays or with no additional hardware outlays at all.

In addition, the ignition system also includes memory media, for example, with the aid of which it is configured to classify the instantaneous energy requirement. In other words, the energy requirement measured in the instantaneous operating state may be compared to energy requirement classes within the memory media. In addition, the memory media may hold predefined switch-on times for the boost converter in store, which have proven suitable for the respective energy requirement classes. In this way, a simple and cost-effective implementation in terms of circuitry of the ignition system is possible.

### BRIEF DESCRIPTION OF THE DRAWINGS

Exemplary embodiments of the present invention are described in detail below with reference to the figures.

FIG. 1 shows a circuit diagram of one exemplary embodiment of an ignition system, in which a method according to the present invention may be used.

FIG. 2 shows time diagrams for electrical parameters as they may occur during operation of the ignition system depicted in FIG. 1.

FIGS. 3a, 3b show time diagrams for electrical parameters as they may occur during the operation according to the present invention of the ignition system depicted in FIG. 1.

FIG. 4 shows a flow chart, illustrating steps of one exemplary embodiment of the method according to the present invention.

### DETAILED DESCRIPTION OF EXAMPLE EMBODIMENTS

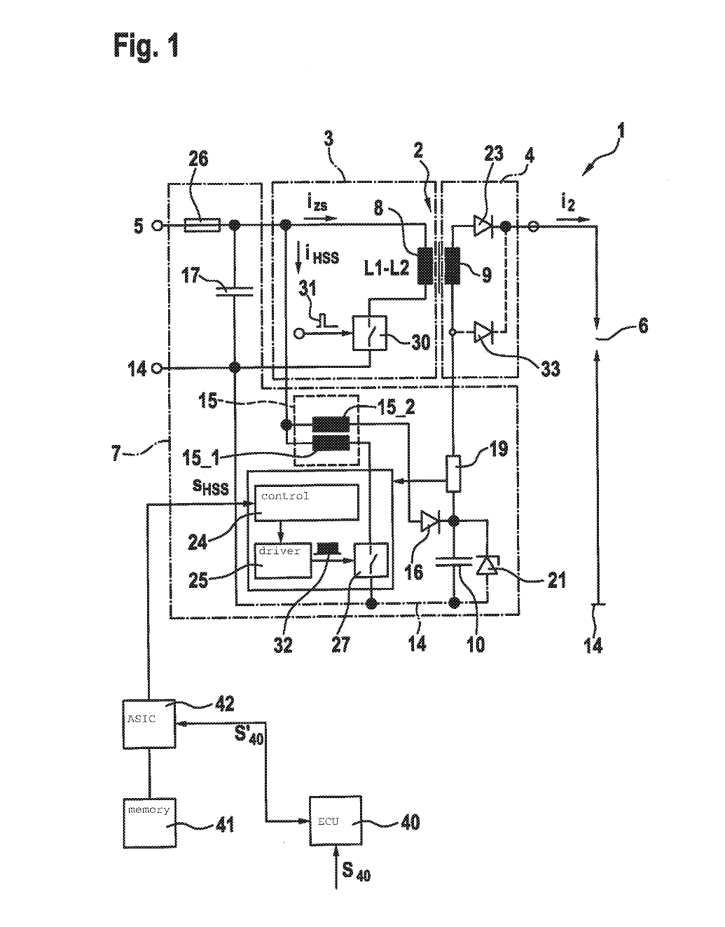

FIG. 1 shows a circuit of an ignition system 1, which includes a step-up transformer 2 as a high voltage generator, the primary side 3 of which may be supplied with electrical energy from an electrical energy source 5 via a first switch 30. Step-up transformer 2 made up of a primary coil 8 and a secondary coil 9 may also be referred to as a first voltage generator or primary voltage generator. A fuse 26 is provided at the input of the circuit, in other words, therefore, at the connection to electrical energy source 5. In addition, a capacitance 17 for stabilizing the input voltage is provided in parallel to the input of the circuit or in parallel to electrical energy source 5. Secondary side 4 of step-up transformer 2 is supplied with electrical energy via an inductive coupling of primary coil 8 and secondary coil 9, and includes a diode 23 known from the related art for suppressing the powering spark, this diode being alternatively substitutable with diode 21. A spark gap 6, via which ignition current i₂ is intended to ignite the combustible gas mixture, is provided in a loop with secondary coil 9 and diode 23 against an electrical ground 14. A boost converter 7 is provided between electrical energy source 5 and secondary side 4 of step-up transformer 2. Boost converter 7 includes an inductance 15, a switch 27, a capacitance 10 and a diode 16. In the boost converter 7, inductance 15 is provided in the form of a transformer having a primary side 15_1 and a secondary side 15_2. Inductance 15 in this case serves as an energy store for maintaining a current flow. Two first terminals of primary side 15_1 and secondary side 15_2 of the transformer are each connected to electrical energy source 5 and fuse 26. In this configuration, a second terminal of primary side 15_1 is connected via switch 27 to electrical ground 14. A second terminal of secondary side 15_2 of the transformer is connected without a switch directly to diode 16 which, in turn, is connected via a node to a terminal of capacitance 10. This terminal of capacitance 10 is connected, for example, via a shunt 19 to secondary coil 9 and another terminal of capacitance 10 is connected to electrical ground 14. The power output of the boost converter is fed via the node at diode 16 into the ignition system and provided to spark gap 6.

Diode 16 is oriented conductively in the direction of capacitance 10. Due to the transfer ratio, a switching operation by switch 27 in the branch of primary side 15_1 also acts on secondary side 15_2. However, since current and voltage according to the transformation ratio are higher or lower on the one side than on the other side of the transformer, more favorable dimensionings for switch 27 for switching operations may be found. For example, lower switching voltages may be implemented, as a result of which the dimensioning of switch 27 is potentially simpler and more cost-effective. Switch 27 is controlled via a control 24, which is connected via a driver 25 to switch 27. Shunt 19 is provided as a current measuring element or voltage measuring element between capacitance 10 and secondary coil 9, the measuring signal of which is fed to switch 27. In this way, switch 27 is configured to react to a defined range of current intensity i₂ through secondary coil 9. A Zener diode is connected in the reverse direction in parallel to capacitance 10 for securing capacitance 10. Furthermore, control 24 receives a control signal S_{HSS}. Via this signal, the feed of energy or power output via bypass 7 into the secondary side may be switched on and off. In the process, the output of the electrical variable introduced by the boost converter and into the spark gap, in particular via the frequency and/or pulse-pause ratio, may also be controlled via a suitable control signal S_{HSS}. In addition, according to the present invention, a switch-on time may be shifted via control signal S_{HSS} if the energy requirement of the ignition spark gap changes. A switching signal 32 is also indicated, with the aid of which switch 27 may be activated via driver 25. When switch 27 is closed, inductance 15 is supplied with a current via electrical energy source 5, which flows directly to electrical ground 14 when switch 27 is closed. When switch 27 is open, the current is directed through inductance 15 via diode 16 to capacitor 10. The voltage occurring in response to the current in capacitor 10 is added to the voltage dropping across second coil 9 of step-up transformer 2, thereby supporting the electric arc at spark gap 6. In the process, however, capacitor 10 is discharged, so that by closing switch 27, energy may be brought into the magnetic field of inductance 15, in order to charge capacitor 10 with this energy again when switch 27 is re-opened. It is apparent that control 31 of switch 30 provided in primary side 3 is kept significantly shorter than is the case with switching signal 32 for switch 27. Optionally, a non-linear two-terminal circuit, symbolized by a high voltage diode 33 depicted with dashed lines, of coil 9 of boost converter 7 on the secondary side, may be connected in parallel. This high voltage diode 33 bridges high voltage generator 2 on the secondary side, as a result of which the energy delivered by boost converter 7 is guided directly to spark gap 6, without being guided through secondary coil 9 of high voltage generator 2. No losses across secondary coil 9 occur as a result and the degree of efficiency is increased. An ascertainment according to the present invention of a modified energy requirement for the spark gap is possible through an information technology linking of engine control unit 40, which receives a first signal S₄₀ for setting an operating point of an internal combustion engine and outputs a corresponding second signal S₄₀′ to a microcontroller 42. ASIC 42 is further connected to a memory 41, from which references in the form of limiting values for classes of energy for the instantaneous or future required electrical energy for maintaining the spark gap may be read. ASIC 42 is configured to influence the working mode of boost converter 7, to supply controller 24 with a control signal S_{HSS} modified according to need or temporally shifted, in response to which driver 25 supplies switch 27 with a modified or temporally shifted switching signal 32. For example, boost converter 7 may be switched on sooner or later in response to the receipt of changed switching signal 32, so that the voltage across diode 10 is lower or higher at the switch-off time of switch 30.

FIG. 2 shows time diagrams for a) ignition coil current i_{zs}, b), associated boost converter current i_{HSS}, c), the voltage on the output side across spark gap 6, d) secondary coil current i₂ for the ignition system depicted in FIG. 1 without (501) and with (502) the use of boost converter 7, e) switching signal 31 of switch 30 and f) switching signal 32 of switch 27. In particular: Diagram a) shows a short and steep rise in primary coil current i_{zs}, which occurs during the time in which switch 30 is in the conductive state (“ON,” see diagram 3e). With switch 30 switched off, primary coil current i_{zs} also drops to 0 A. Diagram b) illustrates in addition the current consumption of boost converter 7, which takes place as a result of a pulsed or clocked activation of switch 27. In practice, clock rates in the range of several 10 kHz have proven to be a reliable switching frequency, in order to achieve corresponding voltages on the one hand and acceptable degrees of efficiency on the other hand. The integral multiples of 10,000 Hz in the range of between 10 kHz and 100 kHz are cited by way of example as possible range limits. To regulate the output delivered to the spark gap during an existing ignition spark, a, in particular, stepless control of the pulse-pause ratio of signal 32 is recommended for generating a corresponding output signal. Diagram c) shows profile 34 of the voltage occurring at spark gap 6 during the operation according to the present invention. Diagram d) shows the profiles of secondary coil current i₂. Once primary coil current i_{zs} results in 0 A due to an opening of switch 30 and the magnetic energy stored in the step-up transformer is discharged as a result in the form of an electrical arc across spark gap 6, a secondary coil current i₂ occurs, which rapidly drops toward 0 without boost converter (501). In contrast to this, an essentially constant secondary coil current i₂ (502) is driven across spark gap 6 by a pulsed activation (see diagram f, switching signal 32) of switch 27, secondary current i₂ being a function of the burning voltage at spark gap 6 and, for the sake of simplicity, a constant burning voltage being assumed here. Only after interruption of boost converter 7 by opening switch 27, does secondary coil current i₂ then also drop toward 0 A. It is apparent from diagram d) that the descending flank is delayed by the use of boost converter 7. The entire period of time during which the boost converter is used, is characterized as t_{HSS} and the period of time during which energy is passed into step-up transformer 2 on the primary side, as tᵢ. The starting time of t_{HSS} as opposed to tᵢ may be variably selected. In addition, it is also possible to increase the voltage supplied by the electrical energy source via an additional DC-DC converter (not depicted), before this voltage is further processed in boost converter 7. It is noted that specific designs are a function of many external boundary conditions inherent to circuitry. The involved person skilled in the art is not presented with any unreasonable difficulties in undertaking the dimensionings suitable for this purpose and for the boundary conditions that must be taken into consideration.

FIG. 3a shows highly simplified time diagrams for illustrating electrical variables, from which the influence of a modified switch-on time tₑ of boost converter 7 on the energy at spark gap 6 in the form of a current l₂ on the secondary side becomes apparent. The upper diagram portion a) shows the case in which the switch-off time tₐ of primary voltage generator 2 is identical to switch-on time tₑ of boost converter 7. At the switch-off time tₐ, the current intensity of current l₂ drops sharply and undercuts minimum value lₘᵢₙ, which is required for ensuring a stable ignition spark. In other words, current l₂ undercuts a threshold value, which may be described as the minimal ignition spark current lₘᵢₙ, and is a function of the voltage at the spark gap. The voltage at spark gap 6 in this case is a function, in particular, of the processes within the combustion chamber of the internal combustion engine. Since boost converter 7 has not yet reached its maximum capacity at the point in time of its switch-on tₑ, it intercepts falling current l₂ too late, which thus lingers at approximately 0.75 ms below limiting value lₘᵢₙ. Only approximately one millisecond after the switch-off of primary voltage generator 2, is current l₂ stable and runs essentially horizontally until control signal 32 switches off boost converter 7.

FIG. 3b shows the influence of an advanced control 32 according to the present invention for boost converter 7. At switch-off time tₐ of primary voltage generator 2, boost converter 7 has achieved a significantly increased capacity, so that current l₂ increases significantly after switch-off time tₐ until, due to falling energy reserves within primary voltage generator 2, it has reached the horizontal level also apparent in FIG. 3a. Due to the increased capacity of boost converter 7, current l₂ does not undercut the threshold value required for a corresponding minimal output, so that a continuously adequate input of energy into spark gap 6 takes place. Current l₂ drops sharply only after control signal 32 for boost converter 7 is switched off and the ignition spark is extinguished. Thus, according to the present invention, variation of switch-on time tₑ of step-up voltage regulator 7 may significantly affect the energy provided to spark gap 6. In this way, an undesirable breakaway of the ignition spark, as well as unnecessary spark erosion at the electrodes of ignition spark gap 6 may be effectively avoided.

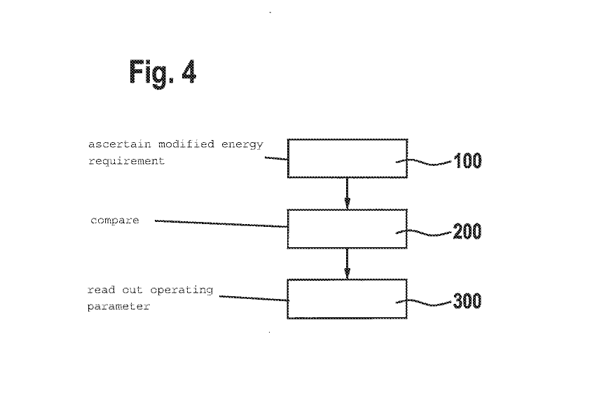

FIG. 4 shows a flow chart, illustrating the steps of an exemplary embodiment of a method according to the present invention. In this embodiment, a modified energy requirement for an ignition spark to be maintained with the aid of the boost converter is ascertained in step 100. During the course thereof, a measurement of an electrical operating variable of the ignition system (in particular, the ignition spark gap) is carried out, and the ascertained value is compared with a stored reference in step 200. An operating parameter associated with the reference, which, for example may be stored as an operating variable class assigned to the measured values, is read out and in step 300, the switch-on time of the boost converter is modified accordingly. For example, the switch-on time may be sooner or later and may be defined relative to a crank shaft angle of the internal combustion engine or relative to the switch-off time of the primary voltage generator. As a result of the modified switch-on time, a high voltage adjusted by the boost converter is delivered to the spark gap, so that a breakaway of the spark or an unnecessarily high electrode erosion may be avoided.

According to one exemplary embodiment, switch-on time tₑ is modified in step 300 as a function of the ascertained operating state and/or as a function of the ascertained energy requirement. Switch-on time tₑ may, in particular, be predefined in a first ignition process as a function of the operating state and be determined for the following ignition processes as a function of the ascertained energy requirement.

According to one exemplary embodiment, the ascertainment of the modified energy requirement includes three steps, the ascertainment of an electrical parameter and/or a change of this parameter and or a change speed of this parameter taking place in step 100. The electrical parameter may, for example, be a current of the ignition spark and/or a voltage characterizing a voltage of the ignition spark. In step 200, it is checked whether an exceedance condition and/or an undercut condition is met by ascertaining whether a comparison variable exceeds a predetermined upper threshold value and/or undercuts a predetermined lower threshold value. The exceedance condition is met if the comparison variable exceeds the predetermined upper threshold value. The undercut condition is met if the comparison variable undercuts the predetermined lower threshold value. The comparison variable is, for example, the ascertained parameter or the change of this ascertained parameter or the change speed of this ascertained parameter. Switch-on time tₑ is modified in step 300, for example, by shifting switch-on time tₑ to a later point in time relative to switch-off time tₐ of primary voltage regulator 2 if the exceedance condition is met, or by shifting switch-on time tₑ to an earlier point in time relative to the switch-off time tₐ of primary voltage generator 2 if the undercut condition is met. In this way, the spark current is adjusted to a value so that neither a spark breakaway is imminent nor a severe erosion of the spark plug electrode occurs. The shifting according to the present invention of switch-on time tₑ in step 300 may take place in predefinable steps or continuously.

A computer program may be provided, which is configured to carry out all described steps of the method according to the present invention. The computer program in this case is stored on a memory medium. As an alternative to the computer program, the method according to the present invention may be controlled by an electrical circuit provided in the ignition system, an analog circuit, an ASIC or a microcontroller, which is configured to carry out all described steps of the method according to the present invention.

Even though the aspects and advantageous specific embodiments according to the present invention have been described in detail with reference to exemplary embodiments explained in conjunction with the figures, modifications and combinations of features of the depicted exemplary embodiments are possible for those skilled in the art, without departing from the scope of the present invention.

1-17. (canceled)

18. A method for operating an ignition system for an internal combustion engine, the ignition system including a primary voltage generator and a boost converter for maintaining an ignition spark generated with the aid of the primary voltage generator, the method comprising:
ascertaining a modified energy requirement for an ignition spark to be maintained with the aid of the boost converter; and
modifying, based on the ascertained modified energy requirement, a switch-on time of the boost converter one of: i) relative to a switch-off time of the primary voltage generator, or ii) relative to a crank shaft angle of an internal combustion engine provided with the ignition system.

19. The method as recited in claim 18, wherein the ascertaining of the modified energy requirement includes measuring at least one of: i) an ignition spark current, ii) an ignition spark voltage, and iii) a voltage corresponding to the ignition spark voltage.

20. The method as recited in claim 18, wherein the ascertaining of the modified energy requirement includes ascertaining an operating state by receiving a signal from an electronic control unit.

21. The method as recited in claim 20, wherein the electronic control unit is an engine control unit.

22. The method as recited in claim 20, wherein at least one of:
the modification of the switch-on time includes a read-out of a switch-on time assigned to the ascertained operating state, and
the modification of the switch-on time includes a classification of the operating state and an application of a switch-on time assigned to the ascertained class.

23. The method as recited in claim 18, wherein the ascertaining of the modified energy requirement includes comparing a measured electrical parameter of an ignition spark or a signal generated by an electronic control unit with an assigned reference.

24. The method as recited in claim 23, further comprising:
classifying the result of the comparison; and
modifying a switch-on time of the boost converter as a function of a parameter assigned to the class.

25. The method as recited in claim 22, wherein the modification of the switch-on time in response to a reduced energy requirement results in a switching on of the boost converter at least one of: i) at a later point in time, and ii) in response to an increased energy requirement, in an earlier switching on of the boost converter.

26. The method as recited in claim 23, wherein:
the ascertainment of a modified energy requirement takes place in the course of a first ignition process, and
the modification of the switch-on time takes place in the course of a second, subsequent ignition process.

27. The method as recited in claim 18, wherein the switch-on time is modified at least one of: i) as a function of the ascertained operating state, and ii) as a function of the ascertained energy requirement.

28. The method as recited in claim 18, wherein the switch-on time is predefined in a first ignition process as a function of an operating state and determined as a function of the ascertained energy requirement for following ignition processes.

29. The method as recited in claim 18, wherein the ascertaining of the modified energy requirement includes:
ascertaining at least one of: i) an electrical parameter, ii) a change of the parameter, and iii) a change speed of the parameter, the electrical parameter being at least one of: i) a current of the ignition spark, and ii) a voltage characterizing a voltage of the ignition spark; and
ascertaining whether at least one of: i) an exceedance condition, and ii) undercut condition, is met by ascertaining whether a comparison variable at least one of: i) exceeds a predetermined upper threshold value, and ii) undercuts a predetermined lower threshold value, the comparison variable being at least one of: i) the ascertained parameter, ii) the change of the ascertained parameter, and iii) the change speed of the ascertained parameter.

30. The method as recited in claim 29, wherein the modification of the switch-on time includes:
modifying the switch-on time to a later point in time relative to the switch-off time of the primary voltage generator if the exceedance condition is met; or
modifying the switch-on time to an earlier point in time relative to the switch-off time of the primary voltage generator if the undercut condition is met.

31. The method as recited in claim 30, wherein the modification of the switch-on time takes place in predefinable steps or continuously.

32. The method as recited in claim 17, wherein the boost converter is switched on with the aid of a switch.

33. A machine-readable memory medium storing a computer program for operating an ignition system for an internal combustion engine, the ignition system including a primary voltage generator and a boost converter for maintaining an ignition spark generated with the aid of the primary voltage generator, the computer program, when executed by a control unit, causing the control unit to perform:
ascertaining a modified energy requirement for an ignition spark to be maintained with the aid of the boost converter; and
modifying, based on the ascertained modified energy requirement, a switch-on time of the boost converter one of: i) relative to a switch-off time of the primary voltage generator, or ii) relative to a crank shaft angle of an internal combustion engine provided with the ignition system.

34. An ignition system for an internal combustion engine, the ignition system including a primary voltage generator and a boost converter for maintaining an ignition spark generated with the aid of the primary voltage generator, the ignition system configured to:
ascertain a modified energy requirement for an ignition spark to be maintained with the aid of the boost converter; and
modify, based on the ascertained modified energy requirement, a switch-on time of the boost converter one of: i) relative to a switch-off time of the primary voltage generator, or ii) relative to a crank shaft angle of an internal combustion engine provided with the ignition system.
